(19) United States
(12) Patent Application Publication
(10) Pub. No.: US 2020/0223114 A1
(43) Pub. Date: Jul. 16, 2020

(54) ANTI-COUNTERFEITING

(71) Applicant: HEWLETT PACKARD ENTERPRISE DEVELOPMENT LP, Spring, TX (US)

(72) Inventors: Adolfo Gomez, 3390 E. Harmony Rd., CO (US); William E. Gallahan, Fort Collins, CO (US); Jack Hui He, Fort Collins, CO (US)

(21) Appl. No.: 16/482,206

(22) PCT Filed: Jan. 30, 2017
(86) PCT No.: PCT/US2017/015661

§ 371 Date: Jul. 30, 2019

(51) Int. Cl. B29C 45/26; B29C 45/37; G03H 1/00; G03H 1/02

(52) U.S. Cl. CPC B29C 45/263; B29C 45/372; G03H 1/0011; G03H 2270/21; G03H 1/0276; G03H 2001/0027; G03H 2001/0284; G03H 1/0244

(57) ABSTRACT

One example includes an injection-molded component comprising a surface surrounded by peripheral edges and which is formed via an injection-molding process. The surface includes a three-dimensional surface feature to render the surface as being non-planar across at least a portion of the surface. The surface also includes a plurality of holographic micro-features formed across the surface and being to interact with ambient light to provide a holographic image corresponding to an authentication mark associated with the injection-molded component.

### BACKGROUND

In modern commerce, it can be very important to a company to maintain control of distribution and authenticity of a given product. To that end, companies typically mark their products with an indication of the source of the product, such as with a trademarked name or logo associated with the company. However, many products can easily be counterfeited to dupe consumers into thinking that a product that they are purchasing is from the counterfeited company, as opposed to a “knock-off” that is typically of inferior quality or which has been surreptitiously manufactured. Product counterfeits can impact a company's revenue stream, perceived quality/reliability, and in certain situations may pose personal safety and property damage risks. Therefore, companies typically attempt to provide anti-counterfeiting measures to render it difficult to replicate their product.

### BRIEF DESCRIPTION OF THE DRAWINGS

FIG. 1 illustrates an example diagram of an injection-molded component.

FIG. 2 illustrates an example of a cross-section of an injection-molded component.

FIG. 3 illustrates an example of a plan-view of an injection-molded component.

FIG. 4 illustrates another example of a plan-view of an injection-molded component.

FIG. 5 illustrates an example of a method for forming an injection-molded component.

### DETAILED DESCRIPTION

An injection-molded component can be formed via an injection molding process. The injection-molded component can be formed, for example, from a variety of different types of materials that can be implemented in an injection-mold, such as a plastic or polymer-based material. The injection-molded component can include a surface that is formed via the injection-molding process. The surface can correspond to a surface that is to be readily visible to a consumer, such as upon purchase and/or installation of the injection-molded component. The surface can include a three-dimensional surface feature that is arranged to render the surface as being non-planar across at least a portion of the surface. The surface also includes a plurality of holographic micro-features formed across at least a portion of the surface, such as including the three-dimensional surface feature. The holographic micro-features can be arranged to interact with ambient light to provide a holographic image corresponding to an authentication mark associated with the injection-molded component. As an example, the holographic micro-features can have spacing and dimensions that can operate similar to a diffraction grating, such that incident optical light is diffracted to alter a wave-front of the reflected optical energy to provide the holographic image. Based on the formation of the holographic micro-features across the non-planar three-dimensional surface feature, it can be very difficult for a counterfeiter to replicate the authentication mark. As an example, the three-dimensional surface feature can substantially mitigate the capability of a counterfeiter to print the authentication mark on a sticker and apply it to the surface of the injection-molded component without significant distortion of the sticker, and thus the authentication mark. As a result, a consumer can visibly notice the three-dimensional surface feature, and thus the undistorted authentication mark, to be able to verify the authenticity of the injection-molded component.

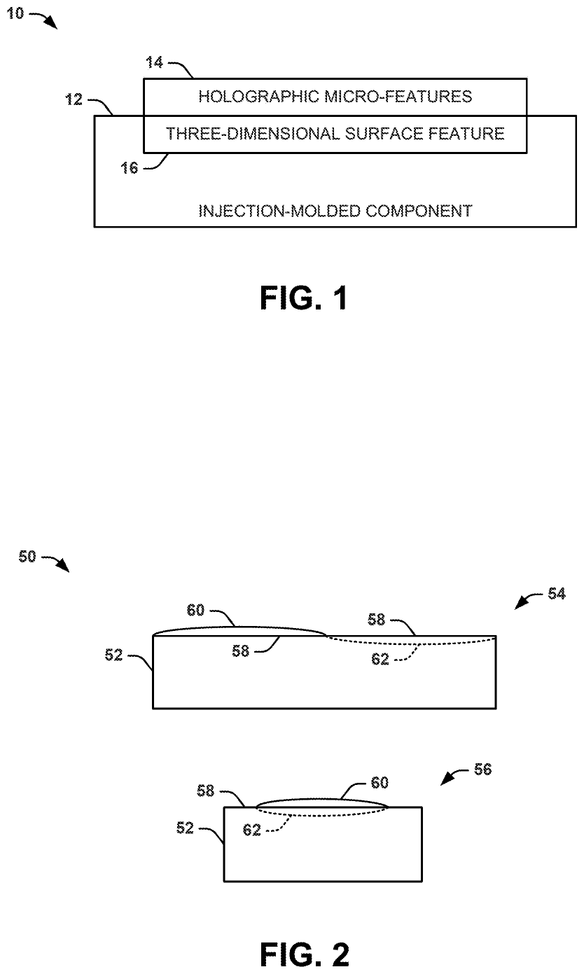

FIG. 1 illustrates an example diagram of an injection-molded component 10. The injection-molded component 10 can correspond to any of a variety of injection-molded devices, such as a package for an integrated circuit (IC) chip, a battery, or any of a variety of other devices for which a manufacturer may want to provide authentication to a consumer. The injection-molded component 10 can be manufactured via an injection-molding process, in which a mold is fabricated via any of a variety of methods (e.g., laser-etching) and subsequently filled with an injection-molding material (e.g., a plastic or polymeric material). Accordingly, the injection-molded component 10 can be formed as a component that is formed as one integral component of the injection-molded material.

The injection-molded component 10 includes a surface 12 that can be defined by peripheral edges. As defined herein, the term “peripheral edges” describes one edge or multiple edges, depending on the shape of the surface 12. For example, “peripheral edges” can refer to a plurality of edges, such as based on the surface 12 having a polygonal shape (e.g., triangle, rectangle, diamond, etc.), or can refer to a single edge that defines the entirety of the periphery of the surface 12 (e.g., a circle or oval shape). Additionally, the peripheral edges are not limited to “corners”, but could instead be curved or sloped. Therefore, the surface 12 is enclosed by the peripheral edges to define a region of the injection-molded component 10 that is visually apparent to a consumer, as described in greater detail herein.

The surface 12 can include a plurality of holographic micro-features 14 and a three-dimensional surface feature 16. The holographic micro-features 14 and the three-dimensional surface feature 16 can be formed via the injection-molding process, such as based via laser-etching and shaping the associated mold. The holographic micro-features 14 can be formed on the surface 12 to provide an interaction with ambient light to provide a holographic image. As described herein, the term “holographic image” or “hologram” describes a visual image of a light field that appears as a three-dimensional image to the naked-eye, and thus the unassisted vision, of a person. The holographic image can correspond to an authentication mark associated with the injection-molded component 10, and can thus be used to provide consumer authentication of the injection-molded component 10, and thus a consumer verification of the authenticity, of the injection-molded component 10. For example, the holographic image provided by the holographic micro-features 14 can correspond to a trademark of the manufacturer of the injection-molded component 10 to provide a first level of consumer authentication of the injection-molded component 10.

The three-dimensional surface feature 16 can correspond to any of a variety of three-dimensional features that can render the surface 12 as being non-planar across at least a portion of the surface 12 that includes at least a portion of the holographic micro-features 14. As described herein, the phrase “non-planar across at least a portion of the surface” refers to the characteristic of the surface 12 as the entirety of the region between all of the peripheral edges as being non-planar. Therefore, while portions of the surface 12 can be planar, the entirety of the surface 12 that is defined by the peripheral edges is non-planar based on the three-dimensional surface feature 16. The three-dimensional surface feature 16 can be formed in the mold, such that the three-dimensional surface feature 16 is formed on the corresponding surface 12 of the injection-molded component 10. Therefore, the holographic micro-features 14 are formed on at least a portion of the three-dimensional surface feature 16, such that the holographic micro-features 14 are collectively not formed on a plane.

As an example, the three-dimensional surface feature 16 can be formed to include at least one curve, and thus can be formed to provide non-linear features on the surface 12. For example, the three-dimensional surface feature 16 can be or can include a convex portion, a concave portion, ridges, bumps, grooves, or a variety of other types of three-dimensional features on the surface 12. As an example, the three-dimensional surface feature 16 can be arranged such that a volume of the injection-molding material of the surface 12 is approximately equal relative to a volume associated with a planar surface having approximately equal dimensions with respect to the peripheral edges. For example, additional molding material that is used to form one or more bumps that extend from one portion of the surface 12 can be approximately equal to a same volume of molding material that would be required to fill a respective one or more depressions that are recessed in another portion of the surface 12.

FIG. 2 illustrates an example diagram 50 of an injection-molded component 52. The injection-molded component 52 can correspond to the injection-molded component 10 in the example of FIG. 1. The diagram 50 demonstrates a first view 54 corresponding to a side-view of the injection-molded component 52, and a second view 56 that corresponds to an end-view of the injection-molded component 52. The diagram thus demonstrates a surface 58 that includes a first portion 60 of a three-dimensional surface feature that corresponds to a convex “bump” extending from the surface 58 and a second portion 62 of the three-dimensional surface feature that corresponds to a concave “depression” recessed into the surface 58. As an example, the additional molding material that is used to form the first portion 60 can be approximately equal to a same volume of molding material that would be required to fill the second portion 62 relative to the surface 58. Accordingly, the three-dimensional surface feature 16 can be formed on the mold in a manner that requires no additional molding material to form the injection-molded component 10, and thus at no additional material cost relative to an equivalent planar surface.

As an example, the three-dimensional surface feature 16 can be visually apparent to the naked-eye of a consumer. For example, a consumer of the injection-molded component 52 in the example of FIG. 2 could be able to see the first and second portions 60 and 62 of the three-dimensional surface feature 16 without any sort of visual aid (e.g., magnification). Therefore, the three-dimensional surface feature 16 can provide additional consumer authentication of the injection-molded component 10. As an example, the manufacturer of the injection-molded component 10 can include instructions, such as in the packaging or on a specification sheet, to the consumer to look for the three-dimensional surface feature 16. Furthermore, because the holographic micro-features 14 can be formed across at least a portion of the three-dimensional surface feature 16, it can be very difficult for a counterfeiter to replicate the holographic image associated with the holographic micro-features 14. For example, because of the non-planar characteristic of the three-dimensional surface feature 16, a counterfeiter could not create a sticker or decal that replicated the holographic image and apply it to the surface 12 of a counterfeited version of the injection-molded component 10 without the holographic image on the sticker or decal becoming distorted. The distortion of the holographic image on the sticker or decal would thus be visually apparent to the consumer, therefore indicating that the counterfeited version of the injection-molded component 10 is not authentic.

For example, it can be relatively easy to reverse-engineer the injection-molded component 10 with respect to size and shape. Therefore, a counterfeiter could reverse-engineer, and therefore replicate, the injection-molded component 10 with respect to the size and shape, including the three-dimensional surface feature 16. However, the holographic micro-features 14 could be very difficult to reverse-engineer for a variety of reasons, such as sensitivity to abrasion, as described in greater detail herein. Therefore, to replicate the holographic image, a counterfeiter could instead print a decal or sticker that included the holographic image, with the intent of adhering the sticker or decal to the surface 12. However, because of the three-dimensional surface feature 16, adhering a sticker or decal to the surface 12 would be substantially impossible without distorting the holographic image. Accordingly, by forming the injection-molded component 10 with the three-dimensional surface feature 16, and by forming the holographic micro-features 14 across at least a portion of the three-dimensional surface feature 16, the ability of a counterfeiter to replicate the holographic image would be substantially mitigated. As a result, it would be very difficult or impossible to counterfeit the injection-molded component 10 without such counterfeiting being visually apparent to the consumer.

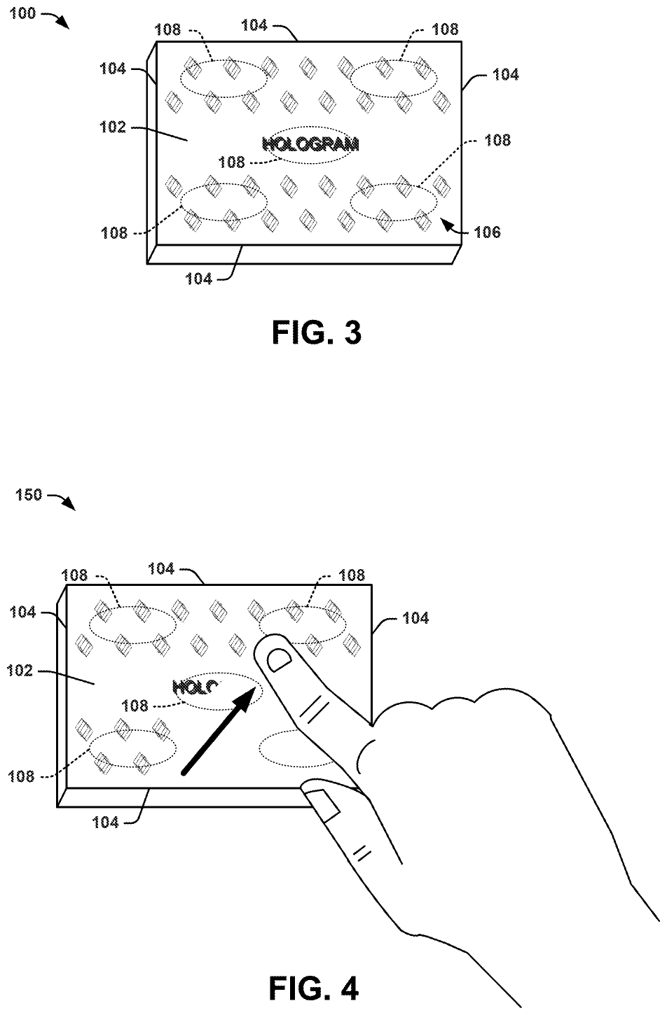

FIG. 3 illustrates an example of a plan-view of an injection-molded component 100. The injection-molded component 100 can correspond to an IC chip, a battery, or any of a variety of other devices for which a manufacturer may want to provide authentication to a consumer. The injection-molded component 100 can be manufactured via an injection-molding process, in which a mold is fabricated via any of a variety of methods (e.g., laser-etching) and subsequently filled with an injection-molding material (e.g., a plastic or polymeric material). Accordingly, the injection-molded component 100 can be formed as a component that is formed as one integral component of the injection-molded material.

The injection-molded component 100 includes a surface 102 that can be defined by peripheral edges 104. The surface 102 can include a plurality of holographic micro-features that are arranged to form a holographic image 106 on the surface 102. The surface 102 also includes a three-dimensional surface feature 108. The holographic micro-features and the three-dimensional surface feature 108 can be formed via the injection-molding process, such as based via laser-etching and shaping the associated mold. The holographic image 106 can correspond to an authentication mark associated with the injection-molded component 100, and can thus be used to provide consumer authentication of the injection-molded component 100, and thus a consumer verification of the authenticity, of the injection-molded component 100. In the example of FIG. 3, the holographic image 106 is demonstrated by the word “HOLOGRAM” and a pattern. However, it is to be understood that the holographic image 106 can be provided as any of a variety of distinctive holographic images that can provide consumer authentication of the injection-molded component 100.

The three-dimensional surface feature 108 can correspond to any of a variety of three-dimensional features that can render the surface 102 as being non-planar across at least a portion of the surface 102 that includes at least a portion of the holographic micro-features. In the example of FIG. 3, the three-dimensional surface feature 108 is demonstrated as a set of five features that can each correspond to a bump (e.g. extension) or a recess (e.g., depression). As an example, each of the five features can be curved. Therefore, the three-dimensional surface feature 108 can be visually apparent to the naked-eye of a consumer. For example, a consumer of the injection-molded component 100 in the example of FIG. 3 could be able to see the five features of the three-dimensional surface feature 108 without any sort of visual aid (e.g., magnification). Therefore, the three-dimensional surface feature 108 can provide additional consumer authentication of the injection-molded component 100. Furthermore, because the holographic image 106 is provided across the three-dimensional surface feature 16, it can be very difficult for a counterfeiter to replicate the holographic image 106 via a sticker or decal. For example, because of the five non-planar features of the three-dimensional surface feature 108, a counterfeiter could not create a sticker or decal that replicated the holographic image and apply it to the surface 102 of a counterfeited version of the injection-molded component 100 without the holographic image on the sticker or decal becoming distorted. The distortion of the holographic image on the sticker or decal would thus be visually apparent to the consumer, therefore indicating that the counterfeited version of the injection-molded component 100 is not authentic.

In addition, based on the injection-molded material, the holographic micro-features can be sensitive to abrasion, and thus destructible without the use of a tool (e.g., the unaided touch), to provide consumer authentication. FIG. 4 illustrates another example diagram 150 of a plan-view of the injection-molded component 100. In the example of FIG. 4, a person (e.g., a consumer) can apply an unassisted touch, demonstrated as a naked finger, and with minimal pressure, can wipe off the holographic image 106. Thus, the holographic image 106 can be easily destructible by a consumer, without the use of a special tool and with minimal effort. As an example, the destructible nature of the holographic image 106 can provide further consumer authentication of the injection-molded component 100 based on a sticker or decal being substantially indestructible to the unassisted and light touch of the consumer. Additionally, consumers can likewise use their sense of touch to verify the three-dimensional surface feature 108, along with the destructible nature of the holographic image 106. Accordingly, the consumer can provide multiple other ways to verify the authenticity of the injection-molded component 100.

The sensitivity of the holographic image 106 to abrasion as a manner of providing further authentication of the injection-molded component 100 is described herein by example. However, it may also be undesirable to some manufacturers for the consumer to destroy the holographic image, either intentionally or unintentionally. Therefore, in the event that the manufacturer of the injection-molded component 100 does not want the consumer to be able to intentionally or unintentionally destroy the holographic image 106, the injection-molded component 100 can include a protective barrier that overlays the surface 102 and which can substantially mitigate the sensitivity of the holographic image 106 to abrasion. For example, the protective barrier can be formed from any of a variety of transparent materials (e.g., plastic, rubber, glass, etc.). As a result, the consumer can touch the surface 102 to verify the presence of the three-dimensional surface feature 108 without destroying the holographic image 106.

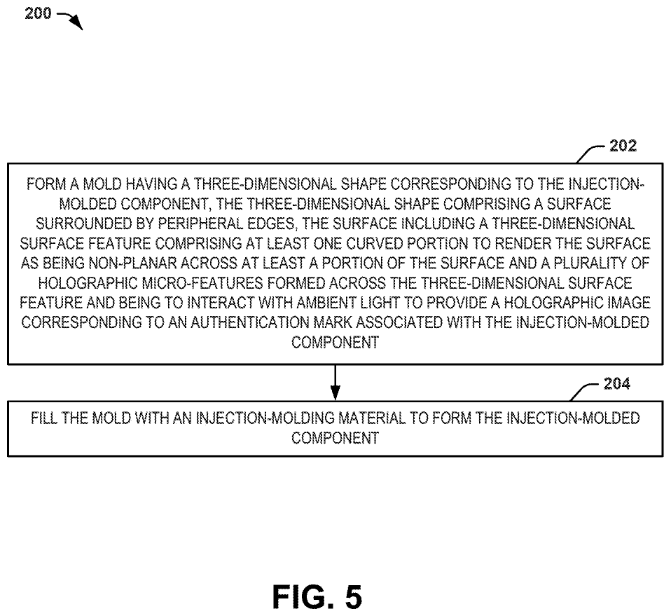

In view of the foregoing structural and functional features described above, an example methodology will be better appreciated with reference to FIG. 5. While, for purposes of simplicity of explanation, the methodology of FIG. 5 is shown and described as executing serially, it is to be understood and appreciated that the present invention is not limited by the illustrated order, as other embodiments occur in different orders and/or concurrently from that shown and described herein.

FIG. 5 illustrates an example of a method 200 for forming an injection-molded component (e.g., the injection-molded component 10). At 202, a mold having a three-dimensional shape corresponding to the injection-molded component is formed. The three-dimensional shape can include a surface surrounded by peripheral edges. The surface can correspond to a surface (e.g., the surface 12) of the injection-molded component. The surface can include a three-dimensional surface feature (e.g., corresponding to the three-dimensional surface feature 16 of the surface 12) comprising at least one curved portion to render the surface as being non-planar across at least a portion of the surface. The surface can also include a plurality of holographic micro-features (e.g., corresponding to the holographic micro-features 14) formed across the three-dimensional surface feature and being to interact with ambient light to provide a holographic image (e.g., the holographic image 106) corresponding to an authentication mark associated with the injection-molded component. At 204, the mold is filled with an injection-molding material to form the injection-molded component.

What have been described above are examples. It is, of course, not possible to describe every conceivable combination of components or methods, but one of ordinary skill in the art will recognize that many further combinations and permutations are possible. Accordingly, the invention is intended to embrace all such alterations, modifications, and variations that fall within the scope of this application, including the appended claims. Additionally, where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is;:

1. An injection-molded component comprising a surface surrounded by peripheral edges and which is formed via an injection-molding process, the surface comprising:
a three-dimensional surface feature to render the surface as being non-planar across at least a portion of the surface; and
a plurality of holographic micro-features formed across the surface and being to interact with ambient light to provide a holographic image corresponding to an authentication mark associated with the injection-molded component.

2. The component of claim 1, wherein the three-dimensional surface feature is visually apparent to the naked-eye to provide consumer authentication.

3. The component of claim 1, wherein the three-dimensional surface feature comprises at least one curved portion.

4. The component of claim 1, wherein the three-dimensional surface feature is arranged such that a volume of injection-molding material of the surface is approximately equal to a volume associated with a planar surface having approximately equal dimensions with respect to the peripheral edges.

5. The component of claim 1, wherein the plurality of holographic micro-features are arranged to be sensitive to abrasion to provide consumer authentication.

6. The component of claim 5, further comprising a protective barrier that overlays the surface and is to substantially mitigate the sensitivity of the plurality of holographic micro-features to abrasion.

7. The component of claim 1, wherein the three-dimensional surface feature comprises at least one of concavity, convexity, a bump, and a ridge.

8. The component of claim 1, wherein the plurality of holographic micro-features are formed across substantially the entirety of the surface between the peripheral edges.

9. The component of claim 1, wherein the plurality of holographic micro-features are formed across the three-dimensional surface feature.

10. A method for forming an injection-molded component, the method comprising:
forming a mold having a three-dimensional shape corresponding to the injection-molded component, the three-dimensional shape comprising a surface surrounded by peripheral edges, the surface comprising:
a three-dimensional surface feature comprising at least one curved portion to render the surface as being non-planar across at least a portion of the surface; and
a plurality of holographic micro-features formed across the three-dimensional surface feature and being to interact with ambient light to provide a holographic image corresponding to an authentication mark associated with the injection-molded component; and
filling the mold with an injection-molding material to form the injection-molded component.

11. The method of claim 10, wherein forming the mold comprises forming the three-dimensional surface feature to be visually apparent to the naked-eye to provide consumer authentication.

12. The method of claim 10, wherein forming the mold comprises forming the plurality of holographic micro-features across substantially the entirety of the surface between the peripheral edges.

13. A mold for forming an injection-molded component, the mold comprising a surface corresponding to a component surface that is defined by peripheral edges, the surface comprising:
a three-dimensional surface feature that is non-planar across at least a portion of the surface, the three-dimensional surface feature comprising at least one curved portion and being visually apparent to the naked-eye with respect to the component surface to provide first consumer authentication of the injection-molded component; and
a plurality of holographic micro-features formed across the three-dimensional surface feature to facilitate interaction of ambient light with corresponding holographic micro-features on the component surface to provide a holographic image corresponding to an authentication mark to provide second consumer authentication of the injection-molded component.

14. The component of claim 13, wherein the three-dimensional surface feature is arranged such that a volume of injection-molding material of the surface is approximately equal to a volume associated with a planar surface having approximately equal dimensions with respect to the peripheral edges.

15. The component of claim 13, wherein the plurality of holographic micro-features are formed across substantially the entirety of the surface between the peripheral edges.
